(19) United States
(12) Patent Application Publication
(10) Pub. No.: US 2019/0335719 A1
(43) Pub. Date: Nov. 7, 2019

(54) EGG COLLECTION AND CARRYING DEVICE

(71) Applicant: Sonya Dunlap, Huntsville, AL (US)

(72) Inventor: Sonya Dunlap, Huntsville, AL (US)

(21) Appl. No.: 16/395,978

(22) Filed: Apr. 26, 2019

Related U.S. Application Data
(60) Provisional application No. 62/665,738, filed on May 2, 2018.

(51) Int. Cl. A01K 45/00

(52) U.S. Cl. CPC A01K 45/005

(57) ABSTRACT

The present disclosure provides an improved egg carrier having a container and an insert.

### CROSS REFERENCE TO RELATED APPLICATIONS

This application claims priority to, and the benefit of, pending U.S. Provisional Patent Application No. 62/665,738 filed on May 2, 2018.

### FIELD OF THE DISCLOSURE

The present disclosure pertains to the field agriculture. More specifically, the present disclosure pertains to an egg carrier 10 adapted and configured to allow a person to both collect chicken eggs and safely transport them from the collection site.

### BACKGROUND

Farmers, especially on small or family owned farms, often enjoy collecting freshly-laid eggs from a small flock of chickens and cooking the fresh eggs for breakfast. This process involves both collecting the eggs, storing them in some sort of storage container and transporting them back inside to the kitchen. In the past, many farmers simply used old egg cartons left over from store bought eggs as the storage container. The use of egg cartons however is both inefficient and the cartons can be difficult to transport without dropping the carton and breaking the eggs. This disclosure provides an improved egg carrier 10 that both protects the eggs during collection and transportation and makes transportation easier.

### BRIEF DESCRIPTION OF THE DRAWINGS

To further illustrate the advantages and features of the present disclosure, a more particular description of the invention will be rendered by reference to specific embodiments thereof which are illustrated in the appended drawings. It is appreciated that these drawings are not to be considered limiting in scope. The invention will be described and explained with additional specificity and detail through the use of the accompanying drawings in which:

FIG. 1 shows one embodiment of the egg carrier 10.

FIG. 2 shows one embodiment of the container 20.

FIG. 3 shows one embodiment of the insert 30.

FIG. 4 shows an alternate view of the insert 30 of FIG. 3.

FIG. 5 shows yet another alternate view of the insert 30 of FIG. 3.

FIG. 6 shows one embodiment of the plate 40.

FIG. 7 shows an alternate embodiment of the egg carrier 10.

### DETAILED DESCRIPTION

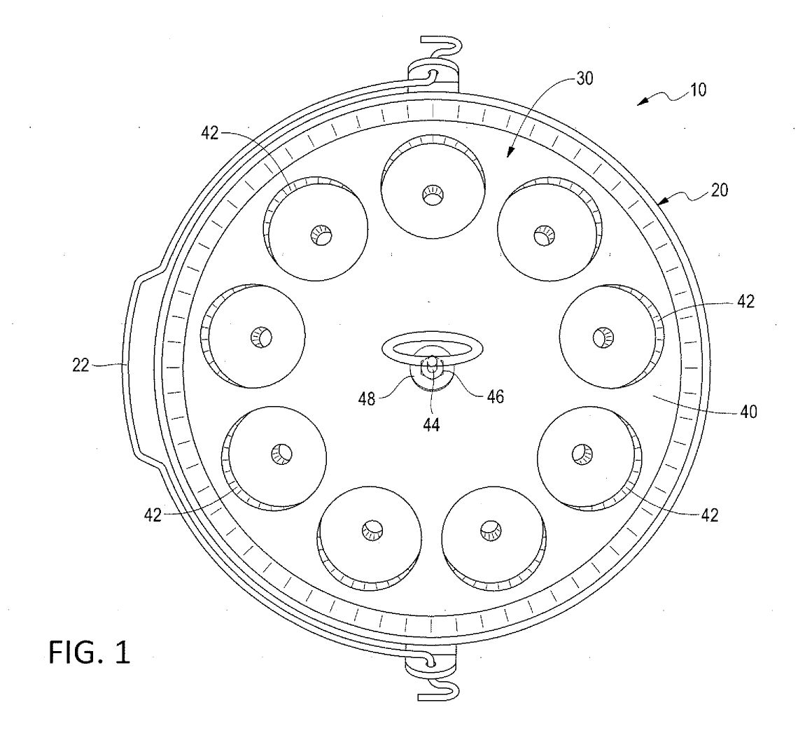

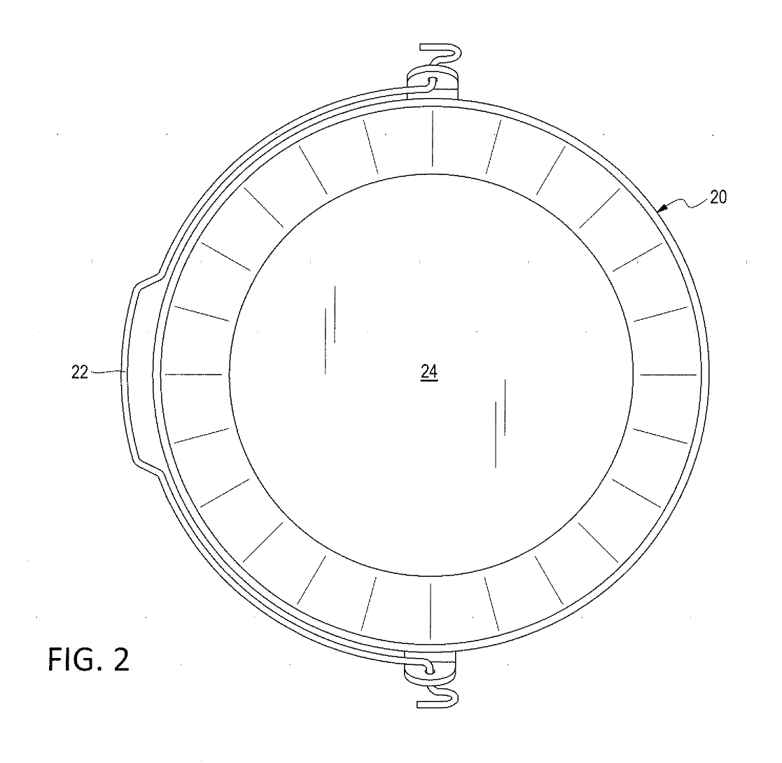

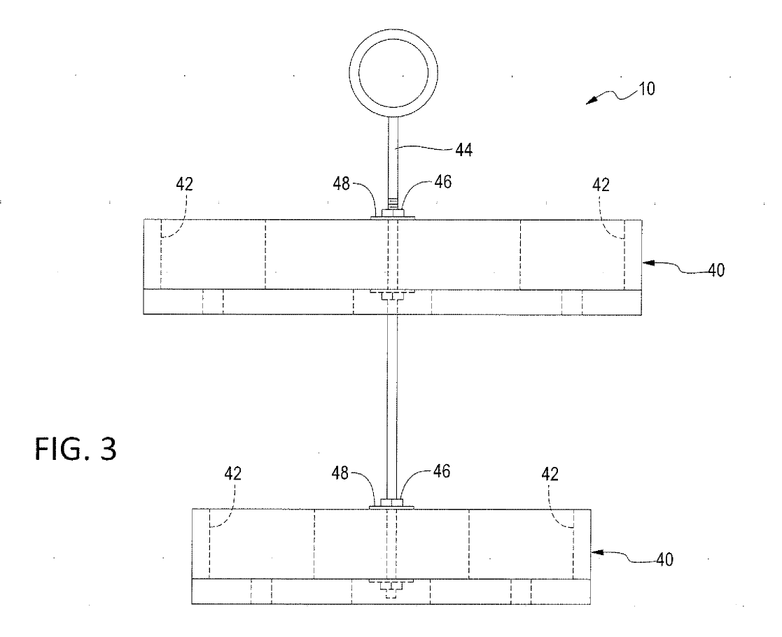

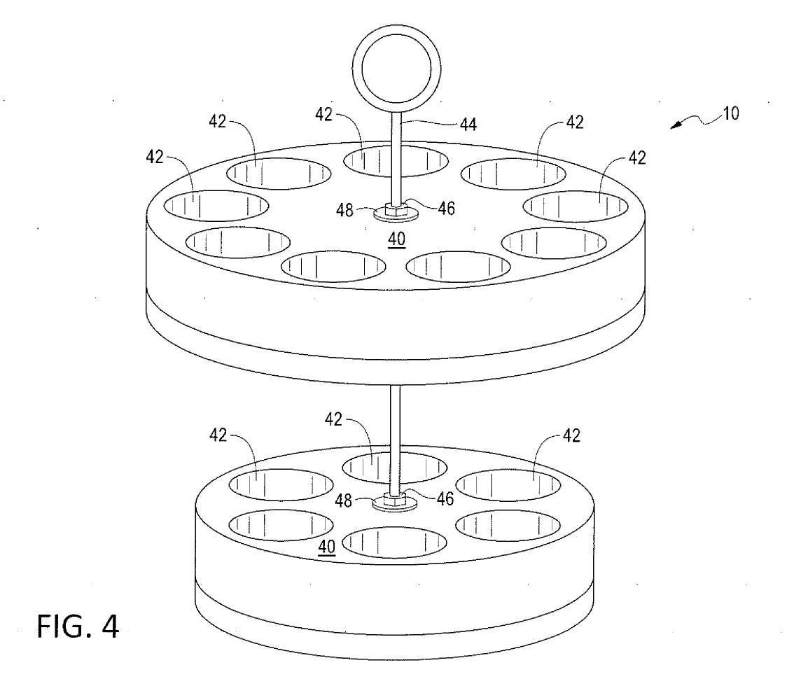

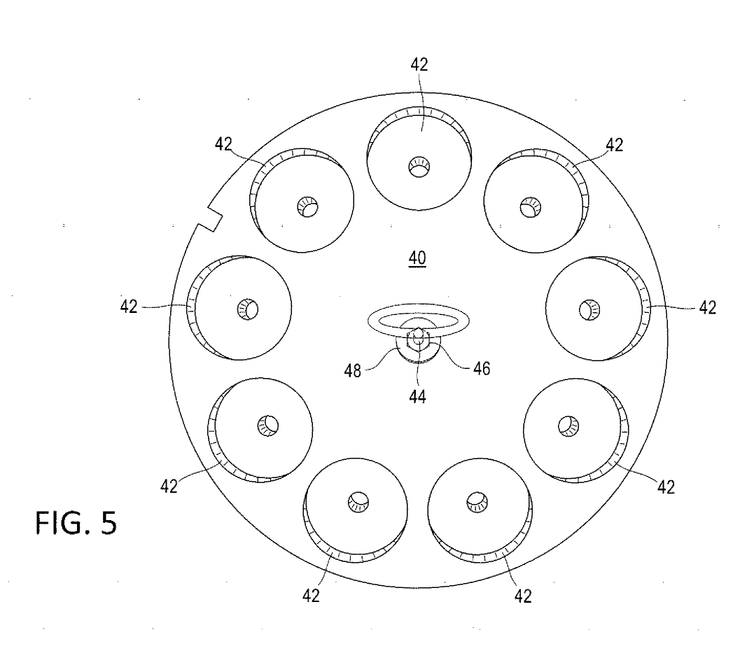

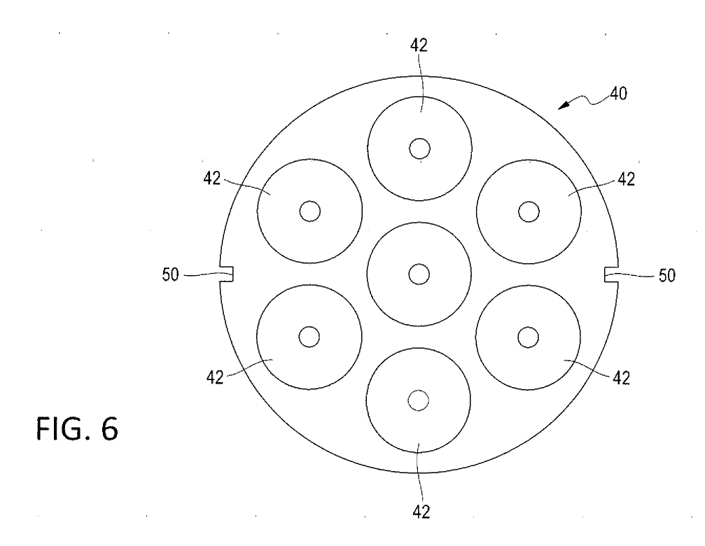

Now referring to FIGS. 1-7, the present disclosure provides an improved egg carrier 10 comprising a container 20 and an insert 30. As discussed below, the insert 30 is comprised of at least one plate 40 having a plurality of receptacles 42 sized and configured to receive an egg.

The container 20 may take many forms. For example, it may be round, square or rectangular. In the embodiment shown in the attached figures, the container 20 is round, although other shapes including oblong, square or any other polygon should be considered within in the scope of this application. In the shown embodiment, the container 20 is a bucket or pail that conveniently provides a handle 22 to aid in transporting the egg carrier 10. The container 20 may also be of varying sizes depending upon the number of plates 40 that are intended to fit within the container 20. Generally, the more eggs that a person wishes to transport, the larger the container 20 must be. Additionally, the container 20, as shown in the attached figures, may have sloping sides which can aid in cleaning the container 20 after use. The container 20 may also be manufactured from many different materials, including galvanized metal, metal, plastic or corrugated cardboard. The container 20 is adapted and configured to receive the insert 30 which is described below.

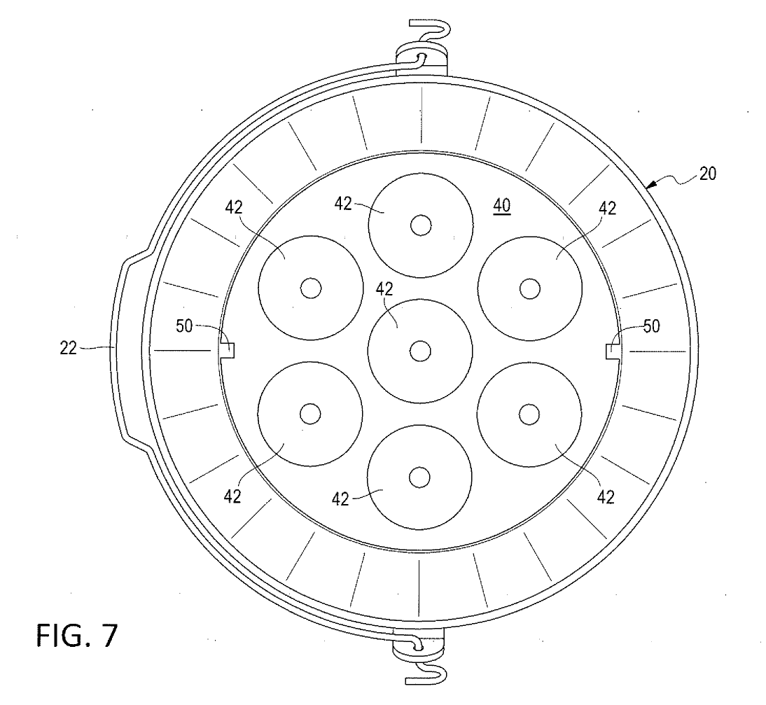

There are many possible embodiments of the insert 30 contemplated in this disclosure. Specifically, FIGS. 1-6 show one embodiment of the insert 30 and FIG. 7 shows another embodiment. Generally, the insert's 30 size and shape should be complimentary to the container's 20 size and shape.

In the embodiment shown in FIGS. 1-6, the insert 30 has more than one plate 40 and a central support 44 which serves to support the plates 40 and maintain their positioning. Alternatively, the plates 40 may not be supported by a central support 44, but rather may be positioned via a friction fit against the sides of the container 20—this embodiment is especially useful if the container has sloping sides as discussed above. The plate 40 will have a plurality of receptacles 42 which are adapted and configured to receive an egg. The exact number of receptacles 42 present on a particular plate 40 depends upon the size of the plate. For example, in the shown embodiment, the upper plate 40 is larger than the lower plate 40 due to the sloping sides of the container 20, so the upper plate 40 has more receptacles 42 (9 vs. 6). Each receptacle 42 also optionally has a hole (unnumbered) in its bottom. This hole allows the water to drain away from the receptacle 42 after the plate 40 is washed to remove any debris. Also, the plates 40 may optionally have a notch 50 on their edge.

The plates 40 may be manufactured from many different materials. In one embodiment, the plates 40 are manufactured from a closed cell foam, such as polyethylene (cross linked or not), neoprene or polyurethane foam. Alternatively, the plates 40 may be manufactured from plastic, wood or some other suitable material. Manufacturing the plates 40 from closed cell foam does offer many advantages as the plates 40 will not absorb any liquid and is easy to clean. The plates 40 may be of a unitary construction (i.e., one piece of material) or they may be constructed from two or more pieces of material.

The plates 40 are spaced vertically from one another and held in position by a central support 44. As shown in FIGS. 1-6, the central support 44 may be a long eye bolt with threads running substantially its entire length or only portions of its length. Additional embodiments within the scope of this application include but are not limited to the central support 44 being formed from the same material as the plates 40. In this embodiment, the plates 40 and the central support 44 could be integrally formed or affixed to one another. As would be recognized by one of skill in the art, there are many other structures that could be the central support 44. The plates 40 are held in place vertically by the central support 44. This securement may be effectuated in many different ways. As shown in FIGS. 1-6, the plates may be bordered by upper and lower washers 46 and nuts 48 which, due to the threads on the central support, can be tightened against the upper and lower surfaces of the plates 40 thereby essentially locking them into position. This embodiment also allows one to remove the washers 46/nuts 48 if desired. For example, if one of the plates 40 is damaged, in this embodiment, the damaged plate may be removed and replaced. Of course, other means and methods of securing the plates 40 to the central support 44 could be used, such as glue or other physical connections. In the embodiment shown in FIGS. 1-6, the central support 44 also has a loop (or eye) on its upper end which aids in handling the egg carrier 10 and/or the insert 30. Additionally, it may be possible to stack the plates 40 in the container 20 without spacing them via a central support 44.

FIG. 7 shows another embodiment of the insert 30 of the present disclosure. This insert 30 only has one plate 40 which is placed into a container 20. This embodiment is especially useful if one is using a small container or only needs to collect a few eggs. In this embodiment, the plate 40 may rest upon the bottom of the container 40 or it may be held in place off of the bottom via a friction fit against the sides of the container 20.

Although particular embodiments of the present disclosure have been described, it is not intended that such references be construed as limitations upon the scope of this disclosure except as set forth in the claims.

I claim:

1. A egg carrier comprising:
a. an outer container,
b. an insert comprising one or more inner plates, wherein each plate comprises multiple receptacles for receiving an egg.

2. The egg carrier of claim 1 wherein the outer container comprises exterior sides forming a central void and wherein the carrier comprises one inner plate held in a suspended position along the sides of the container.

3. The egg carrier of claim 1 wherein the inner plate comprises one or more notches.

4. The egg carrier of claim 1 wherein the carrier comprises at least two (2) inner plates.

5. The egg carrier of claim 4 wherein the inner plates are held in a spaced relationship by a central support.

6. The egg carrier of claim 2 wherein the outer container comprises sloping sides.

7. The egg carrier of claim 4 wherein the outer container comprises sloping sides.

8. The egg carrier of claim 1 wherein the outer container is a bucket.

9. The egg carrier of claim 1 wherein the inner plates consist essentially of closed cell foam.

10. The egg carrier of claim 2 wherein the inner plates consist essentially of closed cell foam.

11. The egg carrier of claim 5 wherein the inner plates consist essentially of closed cell foam.

12. The egg carrier of claim 1 wherein the outer container comprises galvanized metal, plastic or corrugated cardboard.

13. The egg carrier of claim 2 wherein the outer container comprises galvanized metal, plastic or corrugated cardboard.

14. The egg carrier of claim 5 wherein the outer container comprises galvanized metal, plastic or corrugated cardboard.
